(19) United States
(12) Patent Application Publication
(10) Pub. No.: US 2012/0173757 A1
(43) Pub. Date: Jul. 5, 2012

(54) ROUTING OPTIMIZATION FOR VIRTUAL MACHINE MIGRATION BETWEEN GEOGRAPHICALLY REMOTE DATA CENTERS

(75) Inventor: JEFFREY A. SANDEN, Camp Hill, PA (US)

(73) Assignee: INTERNATIONAL BUSINESS MACHINES CORPORATION, Armonk, NY (US)

(21) Appl. No.: 12/985,091

(22) Filed: Jan. 5, 2011

(51) Int. Cl. G06F 15/173; G06F 9/455

(52) U.S. Cl. 709/238; 718/1

(57) ABSTRACT

A system and associated method for optimizing routing of data traffic for a host virtual machine. The host virtual machine communicates with an Internet Protocol (IP) network via a default gateway of a source site prior to migration. A migration service process migrates the host virtual machine from the source site to a target site, which is geographically remote from the source site and consequently changes routing efficiency of the data traffic between the host virtual machine and the IP network. The migration service process reconfigures routing parameters of the migrated host virtual machine for data traffic going out to the IP network from the host virtual machine. The migration service process examines the IP network configurability and subsequently reconfigures the IP network for inbound data traffic coming into the migrated host virtual machine from the IP network when available.

### BACKGROUND

In conventional routing, Internet Protocol (IP) networks operate on a subnet as a unit. Accordingly, when the subnet spans more than one Wide Area Network (WAN) site, data traffic to and from remote hosts with a host in that subnet may be routed via the WAN to another site containing the subnet. With a dynamic infrastructure capable of migrating virtual machines from one site to another, most of data traffic is transferred via suboptimal routes. Consequently, the data traffic is not transferred through an optimal path, causing delay in transfer and response time for the data traffic and adversely affecting overall efficiency of the IP network.

### BRIEF SUMMARY

According to one embodiment of the present invention, a method for optimizing routing of data traffic for a host virtual machine comprises: migrating the host virtual machine from a source site to a target site, wherein the target site is geographically remote from the source site, wherein the source site and the target site belong to a subnet of an Internet Protocol (IP), wherein the host virtual machine communicates with the IP network via a default gateway of the source site prior to said migrating; reconfiguring outbound data traffic of the migrated host virtual machine, wherein the outbound data traffic is a first set of packets originated from the migrated host virtual machine to the IP network, such that the migrated host virtual machine optimally routes the outbound data traffic through the default gateway of the target site; and examining whether the IP network are reconfigurable such that a route of inbound data traffic destined to the migrated host virtual machine is optimized via a default gateway of the target site, wherein the inbound data traffic is a second set of packets transmitted from the IP network to the migrated host virtual machine.

According to one embodiment of the present invention, a computer program product comprises a computer readable memory unit that embodies a computer readable program code. The computer readable program code contains instructions that, when run by a processor of a computer system, implement a method for optimizing routing of data traffic for a host virtual machine.

According to one embodiment of the present invention, a computer system comprises a processor, a memory coupled to the processor, and a computer readable storage device coupled to the processor, said storage device containing program code configured to be executed by the processor via the memory to implement a method for optimizing routing of data traffic for a host virtual machine.

According to one embodiment of the present invention, a process for supporting computer infrastructure, said process comprising providing at least one support service for at least one of creating, integrating, hosting, maintaining, and deploying computer-readable code in a computing system, wherein the code in combination with the computing system is capable of performing a method for optimizing routing of data traffic for a host virtual machine.

### BRIEF DESCRIPTION OF THE SEVERAL VIEWS OF THE DRAWINGS

FIG. 1 illustrates a system for routing optimization for a virtual machine migrated from a geographically remote site within a subnet, in accordance with embodiments of the present invention.

FIG. 2 is a flowchart depicting a method for routing optimization for a virtual machine migrated from a geographically remote site within a subnet, as performed by the migration service process of FIG. 1, in accordance with the embodiments of the present invention.

FIG. 3 illustrates a computer system used for routing optimization for a virtual machine migrated from a geographically remote site within a subnet, in accordance with embodiments of the present invention.

### DETAILED DESCRIPTION

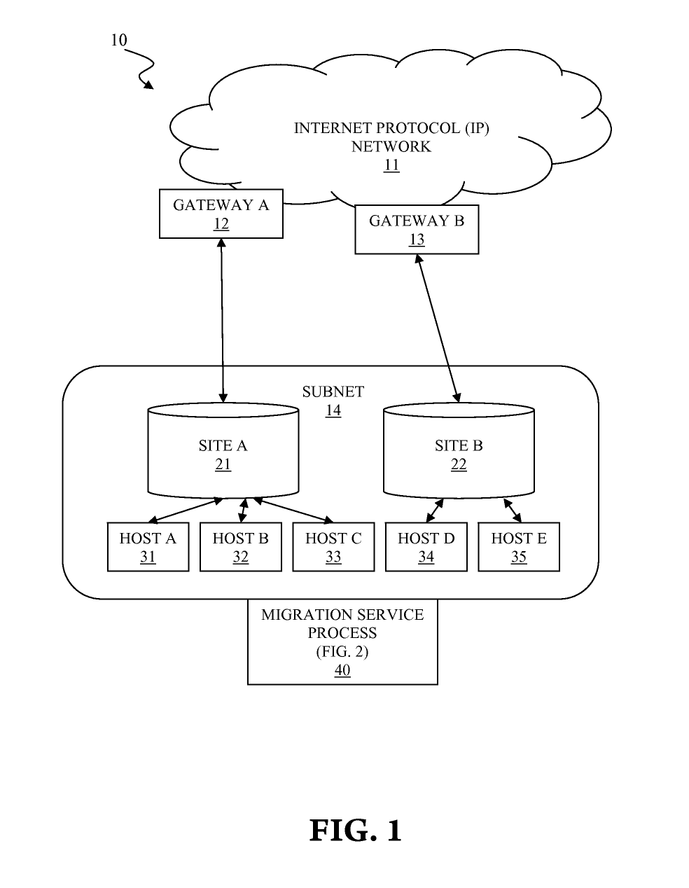

FIG. 1 illustrates a system 10 for routing optimization for a virtual machine migrated from a geographically remote site within a subnet 14, in accordance with embodiments of the present invention.

The system 10 comprises Internet Protocol (IP) network 11, Gateway A 12, Gateway B 13, the subnet 14, and a migration service process 40.

The IP network 11 is a backbone network transferring data traffic based on the Internet Protocol (IP). The IP network 11 is coupled to the subnet 14 via Gateway A 12 and Gateway B 13 for data communication according to the User Datagram Protocol (UDP) and/or the Transmission Control Protocols (TCP) over the Internet Protocol (IP), as commonly referred to as TCP/IP data communication.

The subnet 14 is a logical subdivision of the IP network 11 which comprises Site A 21 and Site B 22. Site A 21 comprises a first set of hosts {Host A 31, Host B 32, Host C 33}. Site B also comprises a second set of hosts {Host D 34, Host E 35}. In one embodiment of the present invention, Site A 21 and Site B 22 are geographically remote data centers administered by an organization, thus Site A 21 and Site B 22 share the subnet 14 and reside in a same broadcast domain. Due to a large amount of data traffic inherent to data centers, changes to suboptimal routing caused by host migration between data centers greatly reduce efficiency and performance of the data centers.

Gateway A 12 is a default router for Site A 21 and Gateway B 13 is a default router for Site B 22, which respectively forwards data packets in and out of each site. Consequently, Gateway A 12 and Gateway B 13 advertise the subnet 14 to the IP Network 11. In addition, to enable optimal routing, Gateway A 12 advertises Host A 31, Host B 32, and Host C 33 in Site A 21 to the IP network 11 for data traffic destination addresses. Gateway B 13 advertises Host D 34 and Host E 35 in Site B 22 to the IP network 11 for data traffic destination addresses. Both Gateway A 12 and Gateway B 13 have a respective routing table that is a database used for forwarding data packets to a respective destination host of each data packet. A routing table of a gateway comprises a route or a forwarding address associated with each destination address, including each host that is serviced by the gateway. In this specification, the routing table of a gateway comprises entries of network route and host route. A network route entry in the routing table holds a network route to a specific network identifier (Network ID) in the IP network 11. A host route entry in the routing table holds a route to a specific network address comprising a network identifier and a host identifier (Network ID, Host ID).

To provide higher availability, Gateway A 12 and Gateway B 13 may support virtual gateways that use a respective virtual IP address that is known to each other to provide a fail-safe routing service for data traffic to and from the IP network 11 and the subnet 14. In this specification, the data traffic going out of a host in the subnet 14 toward the IP network 11 is referred to as outbound traffic, and the data traffic coming into the host in the subnet 14 from the IP network 14 is referred to as inbound. Examples of virtual gateway implementation may be, inter alia, the Virtual Router Redundancy Protocol (VRRP) by the Internet Engineering Task Force (IETF), the Hot Standby Router Protocol (HSRP) by Cisco, etc.

Host A 31, Host B 32, Host C 33, Host D 34, and Host E 35 are all a respective virtual machine that share a set of physical computer systems by use of a hypervisor, or a Virtual Machine Monitor (VMM). Each host virtual machine is created and has a respective static host route within a routing table of a local gateway. The respective static host route is propagated throughout the IP network 11 and the subnet 14. Examples of a hypervisor may be, inter alia, Xen series products by Citrix®, vmkernel by VMWare®, Hyper-V™ by Microsoft®, open source software Kernel Based Virtual machine (KVM), z/VM® by IBM®, etc. (Citrix is a registered trademark of Citrix Systems Inc., in the United States and/or other countries; VMWare is a registered trademark of VMWare Inc., in the United States and/or other countries; Hyper-V is a trademark of Microsoft Inc., in the United States and/or other countries; Microsoft is a registered trademark of Microsoft Inc., in the United States and/or other countries; and z/VM and IBM are registered trademarks of International Business Machines Corporation in the United States and/or other countries).

Each host uses the IP protocol suite to communicate, and has one or more IP interfaces, one of which connects to the subnet 14 shared across Site A 21 and Site B 22. Each host comprises a respective Address Resolution Protocol (ARP) cache and a respective internal routing table. An ARP cache of a host lists mappings between Layer 2 Media Access Control (MAC) addresses and Layer 3 Internet Protocol (IP) addresses of other hosts in the subnet 14 and a default gateway for the host. An internal routing table of a host lists forwarding addresses for traffics to other hosts within the subnet 14.

Site A 21 and Site B 22 are geographically remote even though Site A 21 and Site B 22 share the subnet 14. Site A 21 and Site B 22 are connected in Layer 2 link, by which the migration service process 40 migrates a virtual machine of any host between Site A 21 and Site B 22.

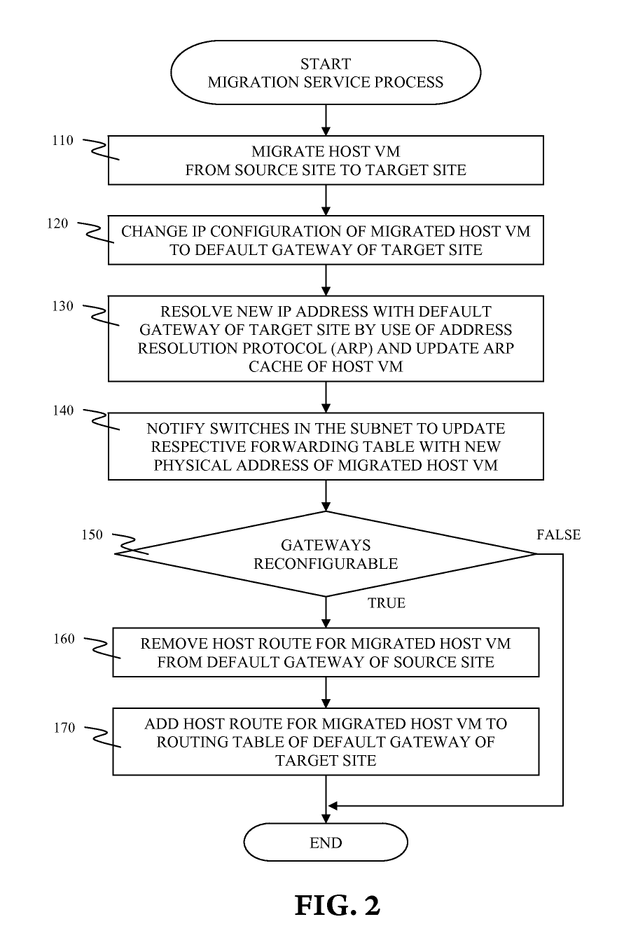

The migration service process 40 migrates any host virtual machine running on a source physical computer system of Site A 21 to a target physical computer system of Site B 22. Migration of the host virtual machine is triggered by various reasons such as resource utilization and workload distribution, etc. In conventional migration service, the host virtual machine operates logically and functionally identical on the source physical computer system and on the target physical computer system. Accordingly, network identity of the migrated virtual machine must remain the same in all layers of interface. Network identity of a host, either virtual machine or physical computer system, comprises Layer 2 Media Access Control (MAC) address, Layer 3 Internet Protocol (IP) address, IP subnet, etc. The migration service process 40 reconfigures a default gateway of the migrated host to optimize suboptimal routing of data traffic. In this specification, only aspects related to routing optimization accompanying a migration service are described. See descriptions of FIG. 2 infra for steps performed by the migration service process 40.

This embodiment of the present invention dynamically optimizes routing for both inbound and outbound traffic of the subnet 14 after migrating host virtual machines between remote sites within the subnet 14 without changing network topology independent from a migrating location.

FIG. 2 is a flowchart depicting a method for routing optimization for a virtual machine migrated from a geographically remote site within a subnet, as performed by the migration service process of FIG. 1 supra, in accordance with the embodiments of the present invention.

In step 110, the migration service process migrates a host virtual machine (VM) from a source site to a target site for various reasons. The target site is geographically remote from the source site. The migrated host virtual machine continues communicating via a default gateway of the source site, which does not optimally route outbound data traffic from the host virtual machine due to the change of location to the target site. In this specification, the term “outbound” indicates a direction of data traffic from the host VM to the default gateway, and the term “inbound” indicated an opposite direction of the data traffic from the default gateway to the host VM. Then the migration service process proceeds with step 120.

In step 120, the migration service process changes Internet Protocol (IP) routing configuration of the migrated host VM to a default gateway of the target site. Then the migration service process proceeds with step 130.

In step 130, the migration service process resolves a new IP address of the migrated host VM with the default gateway of the target site by sending an Address Resolution Protocol (ARP) request when next outbound data packet is sent. The migration service process subsequently updates ARP cache of the host VM with the new IP address. Then the migration service process proceeds with step 140.

In step 140, the migration service process notifies switches in the subnet to update respective Layer 2 Media Access Control (MAC) address tables with the new location of the migrated host VM by initiating the promiscuous Address Resolution Protocol (ARP). In this specification, a location of a host VM is identified by a physical address, which is also referred to as MAC address. In one embodiment of the present invention, a hypervisor performing the migration service issues the promiscuous ARP on behalf of the migrated VM. Then the migration service process proceeds with step 150.

In step 150, the migration service process determines if inbound traffic from the default gateway of the target site to the migrated host VM can be further optimized. The determination is made based on factors, inter alia, the ability of the various routers in the IP network to process host route advertisements from the gateway routers, whether or not the IP network can be reconfigured based on optimization needs of the host VMs, etc. Wherein the IP network is a public backbone network, the migration service process determines that the default gateway of the target site cannot be further optimized. Wherein the IP network is a private network, the migration service process determines that the default gateway of the target site can further optimize inbound traffic to the host VMs. If the migration service process determines that the default gateway of the target site cannot further optimize routing of the inbound traffic to the migrated host VM, then the migration service process terminates reconfiguring network environment for the migrated host VM. If the migration service process determines that the default gateway of the target site can further optimize routing of the inbound traffic to the migrated host VM, then the migration service process proceeds with step 160 to optimize the inbound traffic.

In step 160, the migration service process removes any active host route associated with the migrated host VM from a routing table of the default gateway of the source site, since the host route does not optimally route the inbound traffic after the migration. Then the migration service process proceeds with step 170.

In step 170, the migration service process adds a new host route associated with the migrated host VM to a routing table of the default gateway of the target site. In one embodiment of the present invention, the migration service process uses the Internal Border Gateway Protocol (iBGP) to directly update a next hop for the new host route in the routing table. The migration service process triggers the default gateway of the target site to update static route changes in the Interior Gateway Protocol (IGP) table. Then the migration service process terminates reconfiguring network environment for the migrated host VM.

In one embodiment of the present invention, the system is an autonomous system (AS) that is flexible to change information in gateways and network infrastructure to enable routing optimization of inbound data traffics represented in steps 160 and 170.

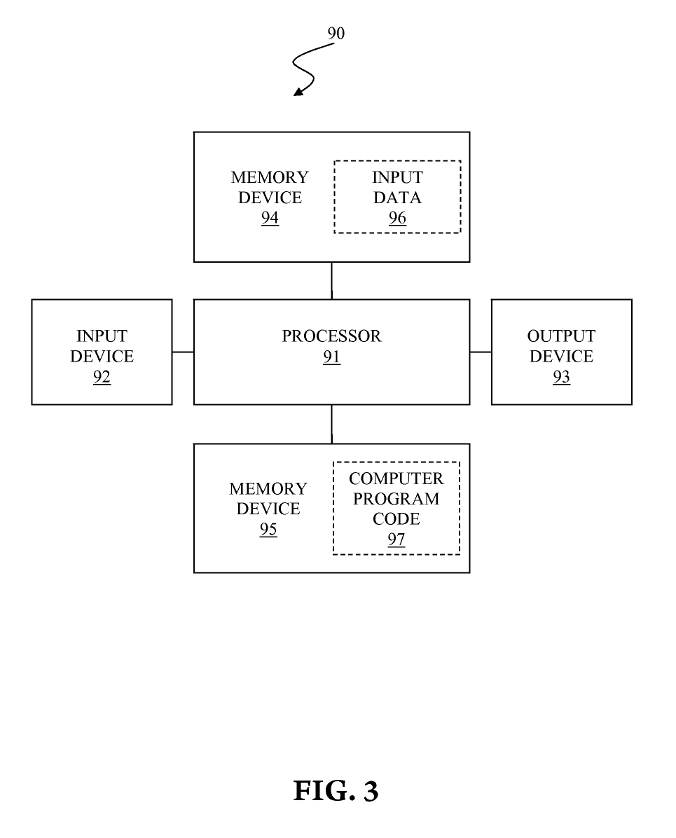

FIG. 3 illustrates a computer system 90 used for routing optimization for a virtual machine migrated from a geographically remote site within a subnet, in accordance with embodiments of the present invention.

The computer system 90 comprises a processor 91, an input device 92 coupled to the processor 91, an output device 93 coupled to the processor 91, and memory devices 94 and 95 each coupled to the processor 91. In this specification, the computer system 90 represents any type of programmable data processing apparatus.

The input device 92 is utilized to receive input data 96 into the computer system 90. The input device 92 may be, inter alia, a keyboard, a mouse, a keypad, a touch screen, a scanner, a voice recognition device, a sensor, a network interface card (NIC), a Voice/video over Internet Protocol (VOIP) adapter, a wireless adapter, a telephone adapter, a dedicated circuit adapter, etc. The output device 93 is utilized to communicate results generated by the computer program code 97 to a user of the computer system 90. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc.

Any of the components of the present invention can be deployed, managed, serviced, etc. by a service provider that offers to deploy or integrate computing infrastructure with respect to a process for routing optimization for a virtual machine migrated from a geographically remote site within a subnet of the present invention. Thus, the present invention discloses a process for supporting computer infrastructure, comprising integrating, hosting, maintaining and deploying computer-readable code into a computing system (e.g., computing system 90), wherein the code in combination with the computing system is capable of performing a method for routing optimization for a virtual machine migrated from a geographically remote site within a subnet.

In another embodiment, the invention provides a business method that performs the process steps of the invention on a subscription, advertising and/or fee basis. That is, a service provider, such as a Solution Integrator, can offer to create, maintain, support, etc., a process for routing optimization for a virtual machine migrated from a geographically remote site within a subnet of the present invention. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 3 shows the computer system 90 as a particular configuration of hardware and software, any configuration of hardware and software, as would be known to a person of ordinary skill in the art, may be utilized for the purposes stated supra in conjunction with the particular computer system 90 of FIG. 3. For example, the memory devices 94 and 95 may be portions of a single memory device rather than separate memory devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. In this specification, the term “memory device” 94, 95 represent a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code 97 for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer program code 97 may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. The term “computer program instructions” is interchangeable with the term “computer program code” 97 in this specification. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for optimizing routing of data traffic for a host virtual machine, the method comprising:
migrating the host virtual machine from a source site to a target site, wherein the target site is geographically remote from the source site, wherein the source site and the target site belong to a subnet of an Internet Protocol (IP), wherein the host virtual machine communicates with the IP network via a default gateway of the source site prior to said migrating;
reconfiguring outbound data traffic of the migrated host virtual machine, wherein the outbound data traffic is a first set of packets originated from the migrated host virtual machine to the IP network, such that the migrated host virtual machine optimally routes the outbound data traffic through the default gateway of the target site; and
examining whether the IP network are reconfigurable such that a route of inbound data traffic destined to the migrated host virtual machine is optimized via a default gateway of the target site, wherein the inbound data traffic is a second set of packets transmitted from the IP network to the migrated host virtual machine.

2. The method of claim 1, said examining comprising:
determining that both the default gateway of the source site and the default gateway of the target site are reconfigurable such that a first route of the inbound data traffic from the default gateway of the source site to the migrated host virtual machine can be replaced with a second route of the inbound data traffic from the default gateway of the target site to the migrated host virtual machine, wherein the first route is longer than the second route; and
reconfiguring the IP network such that the default gateway of the target site optimally routes the inbound traffic from the IP network to the migrated host virtual machine.

3. The method of claim 2, said reconfiguring the outbound data traffic comprising:
changing Internet Protocol (IP) routing configuration of the migrated host virtual machine from the default gateway of the source site to the default gateway of the target site;
resolving a new IP address of the migrated host virtual machine with the default gateway of the target site;
updating Address Resolution Protocol (ARP) cache of the migrated host virtual machine with the resolved new IP address; and
notifying switches in the subnet to update respective Layer 2 address tables with a new physical address of the migrated host virtual machine.

4. The method of claim 2, said reconfiguring the IP network comprising:
removing active host routes destined for the migrated host virtual machine from the default gateway of the source site; and
adding new host routes for the migrated host virtual machine to a routing table of the default gateway of the target site.

5. The method of claim 1, wherein the default gateway of the source site and the default gateway of the target site are virtual gateways that use a respective virtual Internet Protocol (IP) address, wherein a virtual IP address of the default gateway of the source site is known to the default gateway of the target site, wherein a virtual IP address of the default gateway of the target site is known to the default gateway of the source site, such that the default gateways provide a fail-safe routing service for data traffic between the IP network and the subnet.

6. A computer program product comprising:
a computer readable storage device having a computer readable program code embodied therein, said computer readable program code containing instructions that perform optimizing routing of data traffic for a host virtual machine, said optimizing comprising:
migrating the host virtual machine from a source site to a target site, wherein the target site is geographically remote from the source site, wherein the source site and the target site belong to a subnet of an Internet Protocol (IP), wherein the host virtual machine communicates with the IP network via a default gateway of the source site prior to said migrating;
reconfiguring outbound data traffic of the migrated host virtual machine, wherein the outbound data traffic is a first set of packets originated from the migrated host virtual machine to the IP network, such that the migrated host virtual machine optimally routes the outbound data traffic through the default gateway of the target site; and
examining whether the IP network are reconfigurable such that a route of inbound data traffic destined to the migrated host virtual machine is optimized via a default gateway of the target site, wherein the inbound data traffic is a second set of packets transmitted from the IP network to the migrated host virtual machine.

7. The computer program product of claim 6, said examining comprising:
determining that both the default gateway of the source site and the default gateway of the target site are reconfigurable such that a first route of the inbound data traffic from the default gateway of the source site to the migrated host virtual machine can be replaced with a second route of the inbound data traffic from the default gateway of the target site to the migrated host virtual machine, wherein the first route is longer than the second route; and
reconfiguring the IP network such that the default gateway of the target site optimally routes the inbound traffic from the IP network to the migrated host virtual machine.

8. The computer program product of claim 7, said reconfiguring the outbound data traffic comprising:
changing Internet Protocol (IP) routing configuration of the migrated host virtual machine from the default gateway of the source site to the default gateway of the target site;
resolving a new IP address of the migrated host virtual machine with the default gateway of the target site;
updating Address Resolution Protocol (ARP) cache of the migrated host virtual machine with the resolved new IP address; and
notifying switches in the subnet to update respective Layer 2 address tables with a new physical address of the migrated host virtual machine.

9. The computer program product of claim 7, said reconfiguring the IP network comprising:
removing active host routes destined for the migrated host virtual machine from the default gateway of the source site; and
adding new host routes for the migrated host virtual machine to a routing table of the default gateway of the target site.

10. The computer program product of claim 6, wherein the default gateway of the source site and the default gateway of the target site are virtual gateways that use a respective virtual Internet Protocol (IP) address, wherein a virtual IP address of the default gateway of the source site is known to the default gateway of the target site, wherein a virtual IP address of the default gateway of the target site is known to the default gateway of the source site, such that the default gateways provide a fail-safe routing service for data traffic between the IP network and the subnet.

11. A computer system comprising a processor, a memory coupled to the processor, and a computer readable storage device coupled to the processor, said storage device containing program code configured to be executed by the processor via the memory to implement a method for optimizing routing of data traffic for a host virtual machine, the method comprising:
migrating the host virtual machine from a source site to a target site, wherein the target site is geographically remote from the source site, wherein the source site and the target site belong to a subnet of an Internet Protocol (IP), wherein the host virtual machine communicates with the IP network via a default gateway of the source site prior to said migrating;
reconfiguring outbound data traffic of the migrated host virtual machine, wherein the outbound data traffic is a first set of packets originated from the migrated host virtual machine to the IP network, such that the migrated host virtual machine optimally routes the outbound data traffic through the default gateway of the target site; and
examining whether the IP network are reconfigurable such that a route of inbound data traffic destined to the migrated host virtual machine is optimized via a default gateway of the target site, wherein the inbound data traffic is a second set of packets transmitted from the IP network to the migrated host virtual machine.

12. The computer system of claim 11, said examining comprising:
determining that both the default gateway of the source site and the default gateway of the target site are reconfigurable such that a first route of the inbound data traffic from the default gateway of the source site to the migrated host virtual machine can be replaced with a second route of the inbound data traffic from the default gateway of the target site to the migrated host virtual machine, wherein the first route is longer than the second route; and
reconfiguring the IP network such that the default gateway of the target site optimally routes the inbound traffic from the IP network to the migrated host virtual machine.

13. The computer system of claim 12, said reconfiguring the outbound data traffic comprising:
changing Internet Protocol (IP) routing configuration of the migrated host virtual machine from the default gateway of the source site to the default gateway of the target site;
resolving a new IP address of the migrated host virtual machine with the default gateway of the target site;
updating Address Resolution Protocol (ARP) cache of the migrated host virtual machine with the resolved new IP address; and
notifying switches in the subnet to update respective Layer 2 address tables with a new physical address of the migrated host virtual machine.

14. The computer system of claim 12, said reconfiguring the IP network comprising:
removing active host routes destined for the migrated host virtual machine from the default gateway of the source site; and
adding new host routes for the migrated host virtual machine to a routing table of the default gateway of the target site.

15. The computer system of claim 11, wherein the default gateway of the source site and the default gateway of the target site are virtual gateways that use a respective virtual Internet Protocol (IP) address, wherein a virtual IP address of the default gateway of the source site is known to the default gateway of the target site, wherein a virtual IP address of the default gateway of the target site is known to the default gateway of the source site, such that the default gateways provide a fail-safe routing service for data traffic between the IP network and the subnet.

16. A process for supporting computer infrastructure, said process comprising providing at least one support service for at least one of creating, integrating, hosting, maintaining, and deploying computer-readable code in a computing system, wherein the code in combination with the computing system is capable of performing a method for optimizing routing of data traffic for a host virtual machine, said method comprising:
migrating the host virtual machine from a source site to a target site, wherein the target site is geographically remote from the source site, wherein the source site and the target site belong to a subnet of an Internet Protocol (IP), wherein the host virtual machine communicates with the IP network via a default gateway of the source site prior to said migrating;
reconfiguring outbound data traffic of the migrated host virtual machine, wherein the outbound data traffic is a first set of packets originated from the migrated host virtual machine to the IP network, such that the migrated host virtual machine optimally routes the outbound data traffic through the default gateway of the target site; and
examining whether the IP network are reconfigurable such that a route of inbound data traffic destined to the migrated host virtual machine is optimized via a default gateway of the target site, wherein the inbound data traffic is a second set of packets transmitted from the IP network to the migrated host virtual machine.

17. The process of claim 16, said examining comprising:
determining that both the default gateway of the source site and the default gateway of the target site are reconfigurable such that a first route of the inbound data traffic from the default gateway of the source site to the migrated host virtual machine can be replaced with a second route of the inbound data traffic from the default gateway of the target site to the migrated host virtual machine, wherein the first route is longer than the second route; and
reconfiguring the IP network such that the default gateway of the target site optimally routes the inbound traffic from the IP network to the migrated host virtual machine.

18. The process of claim 17, said reconfiguring the outbound data traffic comprising:
changing Internet Protocol (IP) routing configuration of the migrated host virtual machine from the default gateway of the source site to the default gateway of the target site;
resolving a new IP address of the migrated host virtual machine with the default gateway of the target site;
updating Address Resolution Protocol (ARP) cache of the migrated host virtual machine with the resolved new IP address; and
notifying switches in the subnet to update respective Layer 2 address tables with a new physical address of the migrated host virtual machine.

19. The process of claim 17, said reconfiguring the IP network comprising:
removing active host routes destined for the migrated host virtual machine from the default gateway of the source site; and
adding new host routes for the migrated host virtual machine to a routing table of the default gateway of the target site.

20. The process of claim 16, wherein the default gateway of the source site and the default gateway of the target site are virtual gateways that use a respective virtual Internet Protocol (IP) address, wherein a virtual IP address of the default gateway of the source site is known to the default gateway of the target site, wherein a virtual IP address of the default gateway of the target site is known to the default gateway of the source site, such that the default gateways provide a fail-safe routing service for data traffic between the IP network and the subnet.
